(19) United States
(12) Patent Application Publication
(10) Pub. No.: US 2006/0032843 A1
(43) Pub. Date: Feb. 16, 2006

(54) Cutting of cementitious materials

(76) Inventors: Philippus Lodewyk Crouse, Manchester (GB); Lin Li, Manchester (GB); Julian Timothy Spencer, Warrington (GB)

Correspondence Address: DENNISON, SCHULTZ, DOUGHERTY & MACDONALD, 1727 KING STREET, SUITE 105, ALEXANDRIA, VA, 22314, US

(21) Appl. No.: 10/528,822

(22) PCT Filed: Aug. 29, 2003
(86) PCT No.: PCT/GB03/03727

§ 371 Date: Jun. 28, 2005

(30) Foreign Application Priority Data
Sep. 28, 2002 (GB) 0222560.5

(51) Int. Cl. B23K 26/38; B23K 26/14

(52) U.S. Cl. 219/121.72; 219/121.84

(57) ABSTRACT

A method and apparatus for cutting thick sections of cement-based materials, the method comprising mutually traversing a surface to be cut with a laser beam at a power density sufficient to produce a depth of molten material having a maximum depth of 10 mm at each traverse; allowing the molten material to solidify; breaking the solidified material into particles; and removing the particles by suction means.

This invention relates to a method and apparatus for thick-section concrete cutting, e.g. up to 1 m and deeper, particularly, though not exclusively to concrete that has contaminants embedded in the sub-surface matrix, and more particularly, though not exclusively, to concrete that is contaminated by radio-nuclides, where any material which is removed during cutting requires stringent containment.

Nuclear reactors and nuclear processing facilities in general have service lives of approximately 40 years. As part of the decommissioning process the reactor has to be dismantled, and the concrete wall, which may be over 1 m in thickness, that served as a biological shield, has to be broken down. After reactor shutdown, the concrete still contains significant amounts of residual radiation. Common radioactive contaminants are strontium-90, caesium-137, and cobalt-60. During the dismantling process it is imperative that these radio-nuclides are not released into the atmosphere, and that the exposure of site personnel to these substances is kept to an absolute minimum. Conventional techniques for cutting concrete, such as diamond blade and diamond wire sawing, diamond core drilling inclusive of stitch drilling, water jet cutting, and thermite lance cutting, all create substantial amounts of effluent in the form of waste water, dust and fumes which also have to be contained and collected and themselves form part of the volume of waste which has to be treated and stored. Some of these prior art techniques have access difficulties since they require access from both sides of the concrete structure, e.g. diamond wire sawing. They are thus not ideally suitable for this particular application.

Prior art laser-based concrete cutting methods include both single- and multi-pass techniques. In general the most important aspect that controls the depth of cut, is the efficiency with which the molten material can be removed. In the case of single-pass techniques, a hole is typically first drilled mechanically through the concrete after which the beam is traversed across the segment to be cut and the molten material is ejected to the opposite end by the pressure of an assist gas. However, the use of an assist gas brings further difficulties in that it has the effect of cooling down the molten concrete which is already very viscous and difficult to remove thus exacerbating the problem. There are also problems with maintaining the focus of a gas jet in air over deep cutting distances. The focal plane of the laser beam can be placed either at the concrete surface, or below it according to the preference of the operator. However, neither strategy is ideal when attempting to cut a very large thickness in one pass.

Single-pass methods proposed for enhancing efficiency include: using high-pressure gas for assisting the release of molten dross; introduction of explosive powder into the kerf to blow out the molten material; shooting explosive bullets into the kerf and triggering the same using heat generated by the laser beam; enhancing the laser power density by focusing three laser beams on a single spot and blowing the melt out laterally and downwards; introduction of eutectic formers to decrease the fusion temperature of the concrete; and, injection of high-pressure water to cool and crush the molten concrete. Even at power levels as high as 15 kW, these techniques have yet to demonstrate that they can penetrate deeper than 180 mm, and as such are not suitable for deep-section cutting.

For multi-pass strategies the beam is normally focussed on the cutting surface and the molten material is either ejected towards the entering laser beam by an assist gas or allowed to vitrify and removed subsequently. In JP-A-63157778 the laser beam is focused on the surface to be cut and the maximum depth of cut is sought, typically of greater than 45 mm or more using a laser of about 5 kW or more output. After solidification the molten concrete is removed by various mechanical or chemical techniques, and the process is repeated by re-focusing the laser beam on the new surface at the base of the previously treated track. However, problems can arise if the solidified material becomes too thick, since it is effectively glass-like, and in solid, thick pieces can be difficult to remove by rotary brushes, blades and the like. In the case of cutting blades there is a practical limit to the depth to which these can be used.

JP-A-62181898 describes a technique of multi-pass treatment by shooting explosive bullets directly into the melt to eject the molten concrete and to induce local fragmentation of the surrounding solid concrete. This method is clearly dangerous and also has the additional disadvantages of adding to the waste stream and of potentially spreading the contaminated material over a large area, impeding easy retention and collection thereof.

Whilst these prior art methods can in principle go to much greater depths of cut, there are definite limits on the depth achievable by rotary tools and the achievable geometric complexity. In general though, the release of effluent into the atmosphere is difficult to control and, as such, existing technologies are not ideally suited for cutting contaminated material.

A further disadvantage of the prior art methods which tend to try to produce as great a cutting depth as possible is that as a result of the much greater heat input and temperatures reached, the generation of excessive vapour, which may contain relatively large amounts of radioactive species, is correspondingly high and potentially dangerous to people and to the environment and the vapour is not easily contained.

An objective of the present invention is to provide a method and apparatus for effecting deep-section cutting of plain and reinforced contaminated concrete, which allows for easy management of generated waste.

According to a first aspect of the present invention there is provided a method for the cutting of thick sections of cement-based materials, the method comprising the steps of: mutually traversing a surface to be cut with a laser beam at a power density so as to produce a depth of molten material of a maximum of 10 mm at each traverse; allowing said molten material to solidify; breaking said solidified material into small particles; and, removing said small particles by suction means.

According to a second aspect of the present invention apparatus for the cutting of thick sections of cement-based materials comprises: means for mutually traversing a surface to be cut with a laser beam at a power density so as to produce a depth of molten material of a maximum of 10 mm at each traverse; means for breaking melted and re-solidified material into particles; and, means for removing said particles by suction means.

In this specification the term “thick sections” is intended to mean depths of concrete or chemically similar or analogous materials of the order of 1 m or more. However, it should be borne in mind that a method capable of cutting such thicknesses must also be capable of cutting much thinner sections and thus, this term is not to be taken as a limitation.

In this specification the term “cement-based” is intended to cover all common building materials including, for example, Portland cement, concrete having a substantial second phase of aggregate material (the aggregate may be of any type of sand or stone) and a cement matrix and natural stone materials.

Whilst the present invention was developed for cutting contaminated concrete the invention has wider application in general civil and structural engineering where un-contaminated concrete is involved.

Unlike prior art laser-based techniques, this is accomplished by using relatively low laser power densities. The low cut depth per pass means that the degree of heat input is correspondingly less in total and that the degree of vapour formed is lower than in the prior art. Furthermore, the material is melted relatively quickly and because the ratio of volume of melted material to volume of surrounding unmelted material is relatively low, the melted material solidifies quickly and is of a generally weak and porous nature which is easily broken up and removed.

The laser beam may be either defocused, optically parallelised, or preferably, a raw (unfocused, parallel) laser beam may be used. More preferably, the laser beam may be unfocused and parallel but also of substantially rectangular cross sectional shape. The focused laser beams used in the prior art, whilst providing high power densities at the point of impingement on the surface, are unable to cut to any great depth because of the conical nature of the beam and the consequent tapering nature of the cut channel which they form. Parallel beams on the other hand are able to cut to much greater depths. Nevertheless, parallel beams of circular cross section also have apparent limitations in that they also tend to produce a tapering cut channel but the slope of the sides of the cut channel is much less than with focussed beams. The tapering cut produced with circular beams is due to the power density in the beam spot being of a psuedo-Gaussian nature such that the power density at the edges of spot are of lower power density than towards the beam centre line in the direction of movement. Furthermore, with a circular laser beam when the beam is being traversed across a surface, the material at the beam spot lateral edges is subjected to a significantly lower power density for a shorter time than that material inwardly of the beam edges towards the centre. However, even though the kerf width initially tapers quite rapidly, it appears to reach a width where deeper cutting width remains constant.

A rectangular section laser beam such as a square laser beam, for example, overcomes this disadvantage in that when the beam is being traversed across the surface all of the material falling within the spot are at least treated for the same time since the beam spot forms an advancing planar front on the material and beam depth in the direction of travel is also constant.

The solidified material inside the kerf (the “kerf” being the term used for the material removed in the cut or the cut opening) may be broken up by percussive and/or compressive treatment such as by hammering and/or abrasion, for example.

The maximum depth of melted material is 10 mm per pass.

Preferably, however, the thickness of the material melted in each pass may lie in the range from about 0.5 to about 5 mm per pass. More preferably, the thickness may be about 1 to 4 mm per pass. Even more preferably the melted thickness may be about 1 to 2 mm per pass.

The thickness of the molten material is preferably typically kept to a few mm only per pass, in which state minimum force is required for dislodging and crushing the treated material, using a vibrating mechanical device, for example, into pieces small enough to be easily suctioned off and transferred to a filter system by pneumatic transport. By melting only a few millimetres of material per pass the quantity of heat input is minimised and the molten material re-solidifies very quickly and in a very porous and weak condition due partly to out-gassing of relatively volatile constituents such as water of crystallisation, for example. Where the molten layer is too thick, the quantity of heat input is greatly increased and the time for re-solidification of the molten material consequently also increases resulting in the solidified material being more homogeneous, inherently much stronger and consequently more difficult to break up. The kerf may be broken up by a vibrating mechanical, device which may also have a conduit associated therewith so that the broken particles may be removed by suction. It has been found that with the method and apparatus according to the present invention the great majority of the crushed material comprises a particle size of less than 2 mm which is easily removed by suction means.

The crushing and extraction device may be inserted into the cut kerf and follow the movement of the laser beam at a distance sufficient to allow solidification before contact is made.

Pressure exerted on the solidified material to effect crushing is a maximum of about 100 MPa, thus making the process easy.

A mechanical vibrator powering a tubular crusher device, and whose height can be appropriately adjusted may be used. Typically the tip of the crusher is a tubular hardened tool tip appropriately shaped to maximise pressure such as by the inclusion of teeth, for example, at its impacting or cutting end. The crusher can oscillate axially, or rotate or embody both these motions. The diameter of the crushing device should be less than the diameter of the laser beam, i.e. less than the kerf width.

Generally, the concrete matrix may be composed of Portland cement and aggregate. The aggregate is typically sand (˜80% SiO₂), limestone (CaCO₃), basalt, granite, or andesite, with particle diameters ranging from less than 1 mm to over 10 mm. Dry Portland cement in turn is predominantly composed of finely divided SiO₂ and CaO, with smaller quantities of Fe₂O₃, Al₂O₃, and MgO. Upon hydration it forms a complex gel-like structure that contains water bound in the various crystalline phases present as well as free water adsorbed in the complex pore structure of the material. Below an energy-density threshold of about 100 W·cm⁻² to 200 W·cm⁻², differential thermal expansion and/or dehydrated water vapour cause surface layers to dislodge, without any melting taking place, in a process known as “scabbling”. Above this threshold, melting takes place. The exact values of the energy density required for melting and the fusion temperature vary with the quality and composition of the concrete, but in general these are of the order of 300 W·cm⁻² and 1000° C. respectively. Useful laser power densities have been determined to be between about 300 and about 12000 W·cm⁻².

As the depth of the kerf increases and its width narrows slightly, compensatory changes by increasing power density may be made so as to keep the width of the kerf sufficient to permit access for dross removal means.

The outer diameter of a circular laser beam at the point of interaction with the concrete may lie in the range 8-30 mm. Rectangular or other beam shapes are also viable. Temperatures of around 1000° C., just above the melting point of concrete, can be used. The whole temperature range up to the boiling point at 2400° C. is useable if associated fume extraction facilities are strong enough. The concrete temperature and the traverse velocity determine the vapour-to-melt ratio. The workable region for this ratio is between 0.05 and 3. However, in order to minimise fume and vapour generation it is desirable to work at the lower end of the range closer to the melting temperature of the concrete.

The process parameters of prime importance for cutting are: beam traverse speed; laser energy; and, beam spot diameter or area (power density being derived from the latter two values). For this method the gas flow rate is less important when concrete is being cut, the gas essentially being used only to ensure the cleanliness of the optical components by preventing fume and debris from reaching them. During treatment both melting and vaporisation take place. In general both the vapour-to-melt ratio and the depth of cut per pass decrease as power density decreases, and as traverse speed increases. The chosen regime is thus a trade-off between the amount of vapour the user is prepared to contend with, and the minimum cutting speed desired. The larger the beam spot the higher the efficiency of the energy usage. A beam diameter or width at the work surface of about 8-10 mm minimum is preferably required to ensure a kerf width wide enough for optimal entry of percussion crushing and suction tooling. The beam spot is surrounded by a heat-affected zone (HAZ), the area and crushability of which are functions of the operating parameters used. Because of the presence of a HAZ and the movement of the crusher, the kerf width is generally slightly wider than the laser beam diameter.

In one embodiment of the present invention the laser beam may be moved across the work surface at a traverse velocity of between 3cm·min⁻¹ and 40cm·min⁻¹.

The material removal rates vary according to the type of laser. For the diode laser, a mass removal rate of the order of 150 cm⁻³·kWh⁻¹ may be achieved and about 100 cm⁻³·kWh⁻¹ for a CO₂ laser.

The beam may pass through a suction cup, coupled to a HEPA filter and extraction system. The mouth of the suction cup may be positioned as close as possible to the top of the kerf in such a way as to extract any vapour evolved during the process. The cup may be mounted on a robot-driven assembly that houses either the laser oscillator itself, or the components required for focusing the laser output from the outlet of a fibre optic cable, or other beam delivery unit. Typically, the raw beam from a CO₂ or diode laser may be used. However, Nd:YAG, a Fibre laser or chemical oxygen-iodine laser (COIL) can also be used.

Where appropriate the laser system may embody a beam collimator such as a two-lens system for the manipulation of power density to form part of the system of power density control. This enables the beam diameter to be adjusted to a desired size whilst still maintaining beam parallelism.

A diode laser is small and compact and the laser oscillator may form a part of a mobile apparatus. This is particularly relevant as the rectangular form of the laser beam may be retained and which would otherwise be lost if the laser beam is transmitted by fibre optic cable.

Concrete structures are frequently reinforced with metal bars such as steel bars running through the concrete. When such concrete structures are being broken down it is necessary also to cut through the steel bars. In this regard it is advantageous to employ a laser device which has a reserve of power over that required to cut the concrete according to the method of the present invention due to the higher energy density required for cutting the metal, caused by its greater thermal conductivity. A fibre optic monitoring device may be inserted into the kerf to detect the presence of steel bars, and for monitoring the process. Desirably, there should be an oxygen supply able to provide a super-stoichiometric oxygen atmosphere to make full use of the enthalpy of reaction for the oxidation of steel. The metal waste generated may be in the form of relatively finely divided ferric oxide powder or pieces of re-solidified molten steel. Apparatus for carrying out the method of the present invention should desirably include a conduit for supplying oxygen and having an outlet which is positionable as closely as possible to the area of impingement of the laser beam. The aforementioned minimum kerf width makes this readily achievable. Because of the higher thermal conductivity of steel, a higher energy density is required to keep the oxygen-steel reaction above its ignition temperature. This value is typically above 1500 W·cm⁻² for a 15 mm OD steel bar depending on traverse speed. If a lower-power laser is used this can easily be achieved by adjustment of the position of the focal plane. If reinforced concrete is to be cut using a raw laser beam, the energy density of the said beam will have to exceed this value, or a value scaled to the diameter of the steel bars in question. An alternative to laser cutting of the steel bars, is using a flame, e.g. oxy-acetylene, and to use the oxygen delivery system for his purpose.

The laser beam may be directed at the concrete via a hollow suction chamber or cup through which process-generated fumes may be extracted and through which may pass an oxygen delivery tube for directing an oxygen jet at the beam spot when cutting reinforcing steel bars. A percussion-extraction tube may be mechanically coupled to a support structure holding the laser device and positioned a short distance behind the beam spot, for removal of solidified dross. Both extraction streams may pass through an absolute filter system in which radioactive contaminants can be contained according to the needs of the user.

In order that the present invention may be more fully understood, examples will now be described for the purposes of illustration only with reference to the accompanying drawings, of which:

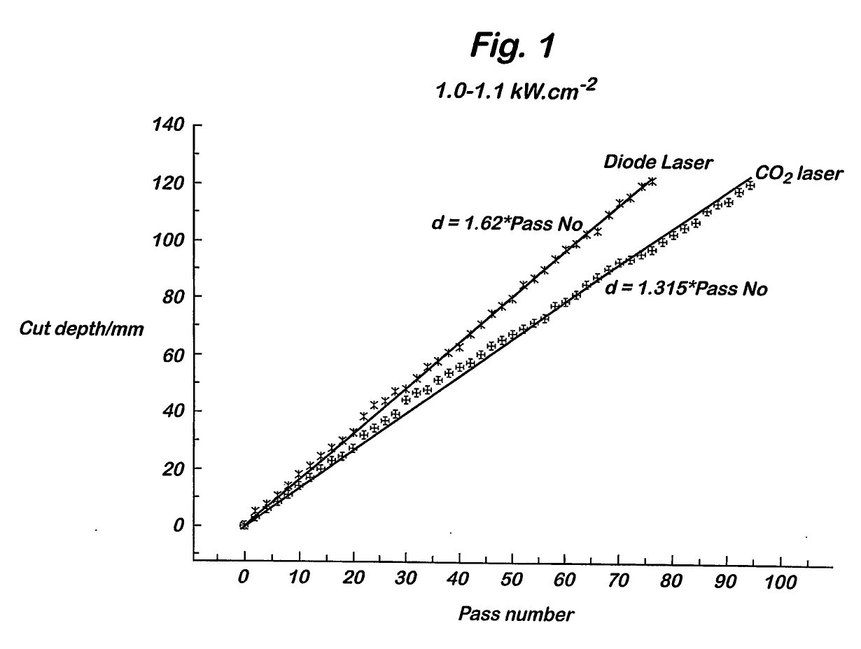

FIG. 1 shows a graph of penetration depth per pass vs pass number for a CO₂ and a diode laser;

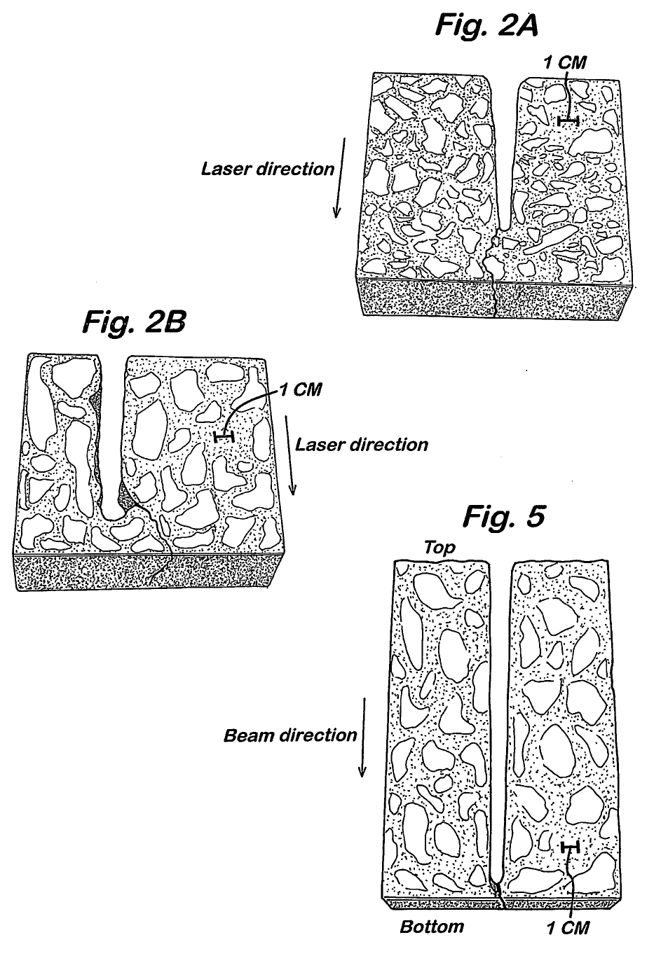

FIGS. 2A and 2B show photographs of concrete slabs cut using a CO₂ laser and a diode laser, respectively;

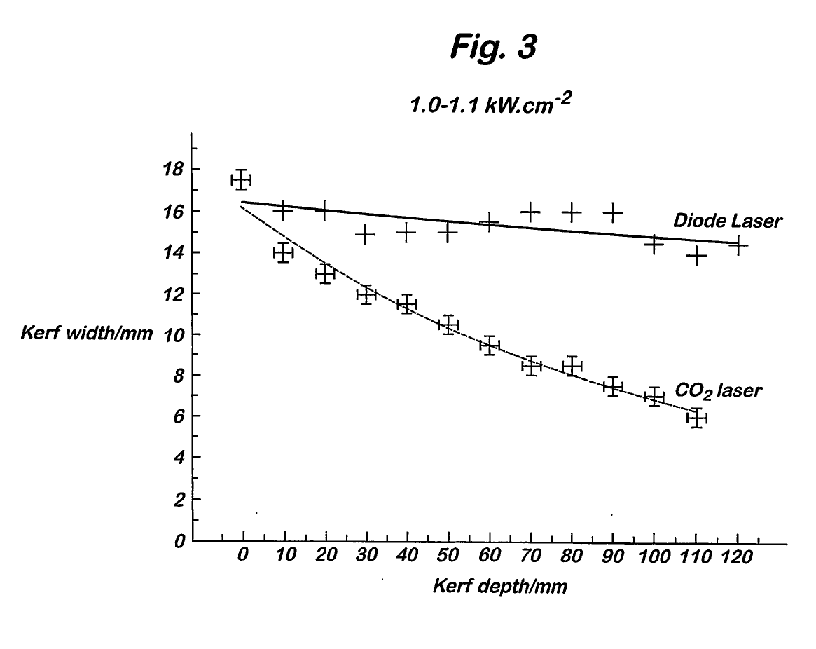

FIG. 3 shows a graph of kerf width vs kerf depth of cut for a CO₂ laser and a diode laser;

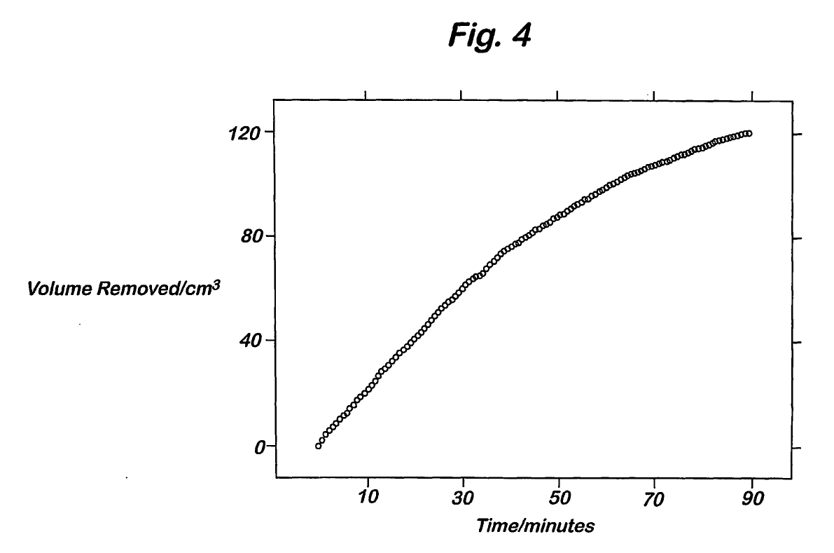

FIG. 4 shows a graph of volume of concrete removed vs time for a CO₂ laser;

FIG. 5 shows a representation of a cut concrete slab under conditions different from the cut slabs shown in FIG. 2;

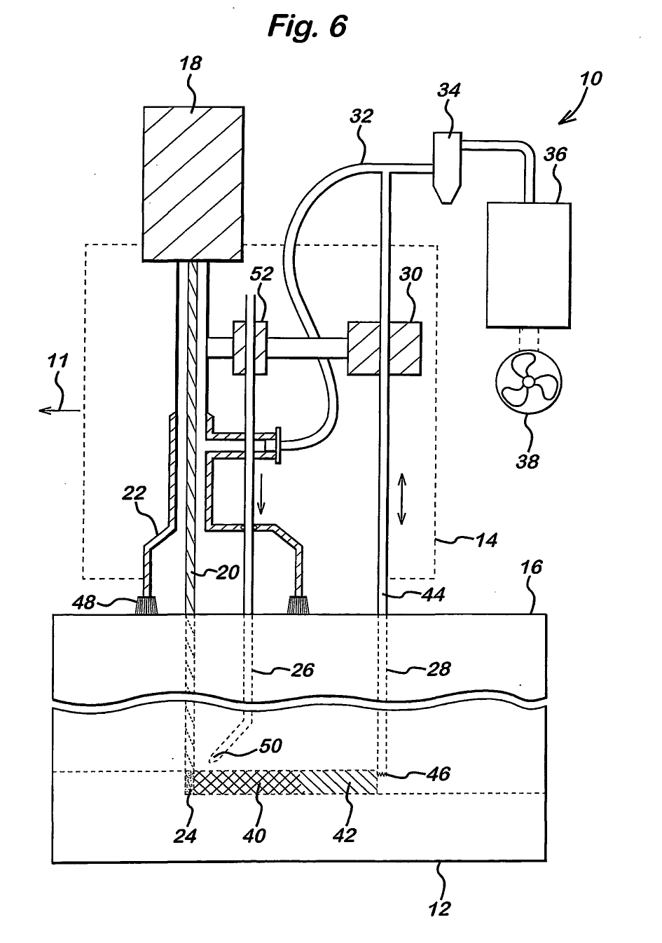

FIG. 6 shows a schematic representation of apparatus according to the present invention for carrying out the method of the present invention; and

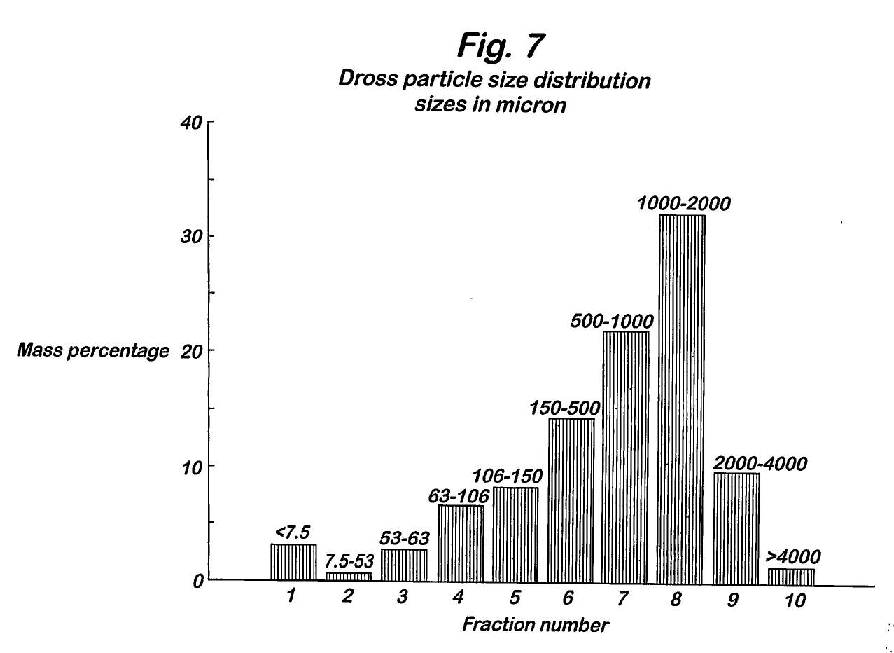

FIG. 7 which shows a histogram of particle size distribution in the crushed kerf material after processing by the apparatus shown schematically in FIG. 6.

Experimental work was carried out using a Rofin-Sinar RS-1000 (trade name) 1.2 kW, fast axial flow CO₂ laser and a Laserline LD-160-1500 (trade name) 1.5 kW high-power diode laser. For comparative work the CO₂ laser yields a circular beam operating in the TEM₀₁ mode, at 10.6 μm, and was fitted with a 125 mm focal length lens. The diode laser yields a rectangular section, multimode beam at 808 and 940 nm and was fitted with a 300 mm focal length lens. The laser beams were traversed relative to the concrete slabs at a speed of 2 m·s⁻¹. In both cases the beam was defocused to give a power density of 1000-1100 W·cm⁻². The distance between the lens and the concrete interaction surface was maintained constant. The diode beam shape was thus kept constant at a rectangular section of dimensions 12 mm×8 mm (with the 12 mm dimension forming the advancing front) and the CO₂ laser beam diameter at 11 mm (measured at the bottom of the kerf). Gas flow rates were kept to a minimum to avoid cooling the molten dross and to protect the lens from fogging.

FIG. 1 shows a graph of kerf cut depth vs pass number. A kerf depth of 120 mm was reached after 74 passes with the diode laser and after 94 passes using the CO₂ laser. An average penetration rate of 1.6 and 1.3 mm was achieved per pass, respectively. From FIG. 1 it is clear that cut kerf depth is substantially constant per pass and that the biggest influence on cut depth per pass is the composition of the concrete at the relevant depth and whether or not limestone aggregate is encountered.

FIGS. 2A and 2B show sections of concrete cut by the CO₂ and diode lasers under the conditions specified in the preceding paragraph, respectively. It may be seen that the kerf cut with the diode laser in FIG. 2A is of much more uniform cross sectional shape than that cut with the CO₂ laser. This difference in cross sectional shape, i.e. tapering more with depth than with the diode kerf is accounted for by the variation in power density across the advancing width of the laser beam as explained hereinabove.

FIG. 3 shows a graph depicting the variation in kerf width with increasing depth and again shows the more uniform kerf width with increasing depth of the diode laser. However, this improved uniformity of kerf width is a feature related to the rectangular cross sectional shape and parallel form of the laser beam rather than the fact that it is a diode laser per se.

FIG. 4 depicts results obtained with plain concrete and the raw beam of a CO₂ laser. Power density in this example was kept constant at a 550 W·cm⁻² and a traverse speed of 120 mm·min⁻¹ was used. The penetration rate is linear, however, the removal rate tapers off slightly due to a narrowing kerf. The narrowing kerf is due to wall losses and to the differential energy density across the circular laser beam as explained hereinabove but is easily compensated for by an appropriate adjustment of the power density. The depth of cut shown in FIG. 5 is 300 mm using a 1 kW laser.

An additional feature which is exploitable when cutting a concrete structure such as a nuclear reactor housing during decommissioning and which is predominantly contaminated on the inside, is that access is possible from the outside, and the laser beam does not have to penetrate the structure fully thus causing undesirable damage to objects on and beyond the inside surface. The thermal stresses which develop during the process invariably cause cracks through the final few centimetres, making laser treatment there redundant. This phenomenon can be seen in FIGS. 2 and 5 where at the bottom of the cut there is clearly a crack extending through the remaining thickness.

FIG. 6 shows a schematic representation of apparatus 10 according to a first embodiment of the present invention. A partially-cut work piece 12 (shown only in part) is static, being part of a larger structure (not shown) being dismantled. The apparatus comprises a housing 14 (shown as an enclosure by a dashed line) which holds and supports in an operable manner various apparatus items which are traversed over the surface 16 of the work piece being cut. The fixture 14 is held in this embodiment by a multi-axis robotic arm (not shown) in known manner. The apparatus items held and supported by the housing 14 include: a source 18 of laser light 20; an extraction cup 22 in the form of a shroud which covers the part of the cut surface in which the point of impingement 24 of the laser beam is located; an oxygen conduit 26; and, a vibrating percussion tool 28 driven by a controllable vibrator/positioning device 30. An extraction and filtering system 32 is connected to the cup 22 and to the percussion tool 28, the extraction system including a cyclone 34 to remove coarser debris, an absolute filter 36 to remove fine particles and, an extractor fan 38.

If a compact CO₂ or high-power diode laser is used, a laser oscillator 18 is mounted and moved along with the aforementioned components. If, however, a Nd:YAG, diode, Fibre or COIL laser is used, the beam 20 can alternatively be delivered by a fibre optic cable and numeral 18 represents an appropriate lens system.

Beam delivery via an appropriate reflecting mirror system (not shown) is also possible.

In use, the housing 14 is traversed across the surface 16 by the robot arm (not shown) in the direction of the arrow 11 and the laser beam point of impingement 24 causes the concrete to melt thereat and leave behind a shallow track 40 of molten material which re-solidifies at 42. The percussion tool 28 in the form of a tube 44 tipped by a wear resistant material 46 follows behind the point of impingement of the laser beam at distance where the molten concrete material has re-solidified at 42 and breaks up the solidified material by reciprocating action generally in the direction of the tube axis and/or by rotation about the tube axis driven by the unit 30. The crushing tube is fitted with a tip manufactured from a hard material such as tungsten carbide or titanium nitride coated tungsten carbide, for example, in order to increase wear resistance, and shaped in such a fashion as to maximise pressure at the points of contact between the tip and the concrete dross. The solidified material breaks up very easily due to the layer thickness being shallow, i.e. less than 5mm, and, because the material has melted quickly with moisture and volatile constituent out-gassing from the melted material itself and from the underlying concrete causing considerable porosity in the quickly re-solidified material which consequently has little strength. In this embodiment the crushing device also serves a second purpose of extracting the crushed material through the tube 44 bore and delivering the debris to the filter system 32 by means of suction provided by the extractor fan 38. The extractor cup 22 is sealed as far as is possible to the surface 16 by seals comprising resilient rubber strips or brushes 48 so as to prevent egress of fume and debris.

The process is controlled in such a way as to keep the thickness of the molten zone 40 below a few mm to ensure that a minimum of pressure is required for crushing the dross, and that it can be accomplished in a controllable way without excessively ebullient vaporisation during the melting phase of the process.

FIG. 7 is a histogram showing the particle size distribution of crushed kerf resulting from the method according to the present invention as depicted in the samples of cut concrete slabs shown in FIGS. 2 and 5. It may be seen that the largest fraction number comprises particles of a size of 1-2 mm with the bulk of crushed material below this figure. Only about 10% of crushed material has particles in the range 2-4 mm and 1-2% at a particle size over 4 mm. Thus, virtually all of the crushed material may be removed by the apparatus shown in FIG. 6.

The kerf width is kept wide enough to allow easy access to the crushing-extraction tube, and which makes depths of out of 1-2 m possible.

Concrete is frequently reinforced with steel bars (not shown) which require cutting if the larger structure is to be dismantled. An oxygen supply tube 26 is provided in order to supply a super-stoichiometric oxygen quantity to assist in cutting such reinforcing bars by enhanced oxidation potential. The positioning of the tip 50 of the tube 26 is accomplished by a mechanical positioning device 52 as indicated in FIG. 6.

Although in the above described embodiment the solidified slag layer is broken up and removed by the combined crusher and suction tube 28, these items may be independently provided such as by a dedicated crushing member and by a separate suction tube following the crushing member. Furthermore, more than one crushing tube/suction device may be provided to deal with remaining particles too large to be removed by the first such device.

1-28. (canceled)

29. A method for cutting thick sections of cement-based materials, the method comprising:
mutually traversing a surface to be cut with a laser beam at a power density sufficient to produce a depth of molten material having a maximum depth of 10 mm at each traverse;
allowing said molten material to solidify; breaking said solidified material into particles; and
removing said particles by suction means.

30. A method according to claim 29 wherein a plurality-of traverses are made along substantially the same cutting path.

31. A method according to either claim 29 wherein the laser beam is unfocused.

32. A method according to claim 29 wherein the laser beam is a parallel beam.

33. A method according to claim 29 wherein the laser beam has a rectangular cross section.

34. A method according to claim 29 wherein the material is removed directly after solidification after each pass.

35. A method according to claim 29 wherein the solidified material is broken up by a hollow crushing tube which also serves as a material extractor conduit.

36. A method according to claim 29 wherein the depth of the molten material at each pass lies in the range from 0.5 to 5 mm.

37. A method according to claim 29 wherein the pressure required for crushing the solidified material is less than 100 MPa.

38. A method according to claim 29 wherein the laser power density lies in the range 300 W·cm⁻² to 3000 W·cm⁻².

39. A method according to claim 29 wherein the beam traverse speed lies between 3 cm·min⁻¹ and 30 cm·min⁻¹.

40. A method according to claim 29 wherein an oxygen jet is applied directly at the beam spot when reinforcing steel bars are being cut.

41. A method according to claim 29 wherein the surface temperature of the material being treated lies in the range 700° C. to 2400° C.

42. A method according to claim 29 wherein the vapor-to-melt ratio lies in the range between 0.05 and 3.

43. A method according to claim 29 wherein the material removal rate lies in the region of 150 cm⁻³·kWh⁻¹ for a diode laser and 100 cm⁻³·kWh⁻¹ for a CO₂ laser.

44. A method according to claim 29 wherein the laser is selected from the group consisting of a COIL, Nd:YAG, CO₂ and diode laser.

45. A method according to claim 29 wherein the laser beam is delivered by a fiber optic cable.

46. A method according to claim 29 wherein the laser beam is delivered by a mobile beam delivery system comprising a system of reflecting mirrors.

47. An apparatus for cutting thick sections of cement-based materials in which material is made molten and allowed to solidify, the apparatus comprising
a means for mutually traversing a surface to be cut with an unfocused laser beam at a power density sufficient to produce a depth of molten material having a maximum depth of 10 mm at each traverse;
a means for breaking the solidified material into particles; and
a suction means for removing the particles.

48. An apparatus according to claim 47 wherein the means for breaking re-solidified material comprises a percussive member for crushing the material.

49. An apparatus according to claim 48 wherein the percussive member is hollow and crushed material is removed through the member by suction means.

50. An apparatus according to claim 47 wherein the laser beam is substantially parallel.

51. An apparatus according to claim 47 wherein the laser beam has a circular or rectangular cross section.
